(19) United States
(12) Patent Application Publication
(10) Pub. No.: US 2025/0378057 A1
(43) Pub. Date: Dec. 11, 2025

(54) METHOD AND SYSTEM FOR EFFICIENT SAMPLING AND SHUFFLE OPERATIONS WITHIN A KEY-VALUE STORAGE ENGINE FOR AI TRAINING WORKFLOWS

(71) Applicant: Pliops Ltd., Tel Aviv (IL)

(72) Inventors: Moshe Twitto, Givat Shemuel (IL); Aryeh Mergi, Tel Aviv (IL); Eshcar Hillel, Tel-Aviv (IL)

(73) Assignee: Pliops Ltd., Tel Aviv (IL)

(21) Appl. No.: 19/230,016

(22) Filed: Jun. 5, 2025

Related U.S. Application Data
(60) Provisional application No. 63/657,070, filed on Jun. 6, 2024.

(51) Int. Cl. G06F 16/22

(52) U.S. Cl. CPC G06F 16/2255

(57) ABSTRACT

The present disclosure provides a method for performing sampling operations within a key-value storage engine for AI training workflows, comprising organizing data as key-value pairs within the key-value storage engine, where each key is stored in memory and points to a corresponding value stored in a storage unit, implementing an enhanced iterator initialization function that accepts a database name, a start key, a sampling ratio parameter that determines a proportion of data to be scanned from an entire database, and a seed parameter that serves as a randomization seed, executing a random permutation over a subset of the dataset based on the sampling ratio and seed parameters, and returning values based on the randomized permutation using iterator operations, thereby performing sampling operations directly within the key-value storage engine without requiring intermediate data transfers.

### CROSS-REFERENCE TO RELATED APPLICATIONS

This application claims priority to U.S. Provisional Patent Application No. 63/657,070, filed Jun. 6, 2024, which is hereby incorporated by reference in its entirety.

### FIELD OF INVENTION

The present disclosure relates to data processing systems for artificial intelligence training workflows, and more particularly to a method and system for performing efficient sampling and shuffle operations directly within a key-value storage engine to optimize AI training data preprocessing pipelines.

### BACKGROUND

Artificial intelligence and machine learning systems have experienced rapid growth and adoption across numerous industries and applications. As these systems become more sophisticated and handle increasingly complex tasks, the volume and diversity of training data required to develop effective AI models has expanded substantially. Modern AI training workflows often involve processing massive datasets that may contain millions or billions of data points, presenting substantial challenges for data management and preprocessing operations.

Traditional data processing approaches for AI training typically involve multiple stages of data preparation, including sampling operations to select representative subsets of data and shuffle operations to randomize data ordering. These preprocessing steps help ensure that AI models receive appropriately distributed training data and avoid potential biases that could arise from systematic data ordering. However, conventional approaches often require data to be moved between different storage systems and processing components, creating potential bottlenecks in the training pipeline.

Key-value storage systems have emerged as popular solutions for managing large-scale datasets due to their simplicity and efficiency in storing and retrieving data. These systems organize information as collections of key-value pairs, where each piece of data is associated with a unique identifier. The straightforward structure of key-value storage enables rapid data access and manipulation operations, making it suitable for applications that require frequent data retrieval and updates.

Conventional key-value storage engines typically provide basic operations such as inserting, retrieving, and deleting key-value pairs. These systems may also support additional functionalities including data iteration, range queries, and transaction management. Data iteration in traditional key-value systems often involves using iterator objects that traverse datasets sequentially or according to specified criteria.

As AI training datasets continue to grow in size and complexity, the computational overhead associated with data preprocessing operations has become increasingly apparent. Traditional approaches may require significant data movement between storage systems and processing units, potentially creating performance bottlenecks that slow down the overall training process. Additionally, the separation between data storage and preprocessing operations may result in inefficient resource utilization and increased infrastructure costs.

The dynamic nature of AI workloads presents additional challenges for data processing systems. Different training scenarios may require varying sampling ratios, different randomization patterns, or concurrent access to the same dataset by multiple processing units. Traditional storage and preprocessing architectures may struggle to accommodate these diverse requirements while maintaining optimal performance characteristics.

Modern AI training environments often involve specialized processing hardware such as graphics processing units and dedicated AI accelerators. These systems may benefit from direct access to preprocessed data without requiring intermediate transfers through general-purpose computing components. However, conventional data processing pipelines may not provide the necessary interfaces or optimization for direct integration with specialized AI hardware.

Therefore, enhanced approaches for integrating data preprocessing operations with storage systems may provide advantages for AI training workflows by reducing data movement overhead, improving resource utilization, and enabling more efficient coordination between storage and processing components.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for performing sampling and shuffle operations within a key-value storage engine for AI training workflows is provided. The method includes organizing data as key-value pairs within the key-value storage engine, where each key is stored in memory and points to a corresponding value stored in a storage unit. The method includes implementing an enhanced iterator initialization function that accepts parameters including a database name, a start key, a sampling ratio parameter that determines a proportion of data to be scanned from an entire database, and a seed parameter that serves as a randomization seed. The method includes executing a random permutation over a subset of the dataset based on the sampling ratio and seed parameters. The method includes returning values based on the randomized permutation using iterator operations, thereby performing sampling and shuffle operations directly within the key-value storage engine without requiring intermediate data transfers.

According to other aspects of the present disclosure, the method may include one or more of the following features. The key-value storage engine may be structured as an in-memory hash table, where each entry points to a location of an entry value on storage media. The hash table may comprise N=2ⁿ slots for some n, which accommodate M entries, where distribution of entries across slots adheres to balls and bins principles. The method may employ an invertible hash function that can be generated differently for each seed. The invertible hash function may utilize operations selected from the group consisting of multiplication by an odd constant, addition of a constant, and bit rotation operations. The method may define a random permutation over n+1 bits where 1 represents a maximum number of collisions within a slot. The method may emit key-value pairs based on content of chosen slots using a sequential algorithm that iterates over the hash table without requiring additional memory for storing additional data structures. The method may be executed on a dedicated processor external to a system CPU, such as an ASIC or FPGA. The method may provide direct access from an AI processor such as a GPU, thereby circumventing a CPU subsystem. The method may consolidate an entire array of vectors into a single value while retaining internal structure details when dealing with datasets that can be accommodated entirely in memory, and may load all data into memory in a single I/O operation before applying the random permutation algorithm.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is an example of a method.

FIG. 2 is an example of a request.

FIG. 3 is an example of a system.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to enhanced key-value storage engines for artificial intelligence training workflows. Traditional data processing approaches for AI training may involve performing sampling and shuffle operations over conventional storage mechanisms, which can present limitations in scalability and performance. The disclosed techniques address these challenges by integrating sampling and shuffle operations directly within a key-value storage engine.

Key-value storage systems may organize data as collections of key-value pairs, where each key is stored in memory and points to a corresponding value stored in a storage unit. Conventional application programming interfaces for key-value storage engines may include basic create, read, update, and delete operations such as put, get, and delete operations. These interfaces may also provide additional functionalities including iteration, range queries, and transaction support. In some cases, the system may organize different collections of distinct data into logical buckets or databases for segregation and management into separate namespaces, providing flexibility and organization in large-scale applications.

The disclosed approach enhances traditional key-value storage engine interfaces by introducing functionalities designed to streamline the management of random sampling and data shuffling operations. In some cases, the enhanced system may return values based on randomized permutation using iterator operations, thereby performing sampling operations directly within the key-value storage engine without intermediate data transfers. This approach may eliminate the computational overheads and data movement bottlenecks associated with conventional preprocessing pipelines.

In some cases, the system may facilitate multiple concurrent shuffle operations by numerous initiators on identical data without modifying the index or the data itself. This capability may enable efficient resource utilization and improved scalability for AI training workflows that involve multiple concurrent processes accessing the same dataset.

The key-value storage engine provides a foundational data organization structure that facilitates efficient data management and retrieval operations. In some cases, data may be organized as key-value pairs within the key-value storage engine, where each key is stored in memory and points to a corresponding value stored in a storage unit. The key stored in memory serves as a reference point for accessing the associated value in the storage unit, enabling rapid data retrieval and manipulation operations while maintaining separation between the indexing structure and the actual data storage.

The key-value storage engine may be structured as an in-memory hash table. In some cases, each entry in the hash table points to a location of an entry value on storage media. This configuration allows the hash table to function as a mapping mechanism that maintains references to actual data stored on persistent storage devices while keeping the indexing structure in memory for enhanced access performance. The separation between keys stored in memory and values stored in the storage unit enables efficient memory utilization and optimized data access patterns.

The hash table may comprise N=2ⁿ slots for some integer n, which accommodate M entries. In some cases, the selection of N=2ⁿ slots provides computational advantages for hash function operations and memory addressing schemes. The parameter n may be chosen based on the expected data volume and performance requirements of the storage engine.

Distribution of entries across the N=2ⁿ slots may adhere to balls and bins principles. In some cases, the balls and bins model describes how M entries (balls) are distributed among N slots (bins) in the hash table. This distribution pattern may influence collision rates and access patterns within the hash table structure. The balls and bins principles may govern the statistical properties of entry placement, where entries are distributed across available slots according to hash function outputs.

In some cases, the hash table configuration accommodates varying loads where M entries are distributed across the available N slots. The relationship between M and N may influence the collision characteristics and performance metrics of the storage engine. When M entries are placed into N=2ⁿ slots, the distribution may follow probabilistic patterns consistent with random placement models, affecting the efficiency of data access operations.

The enhanced iterator initialization function represents a modification to conventional key-value storage engine APIs. In conventional systems, data iteration may be achieved using an iterator object that accepts a database name and a start key as parameters. The conventional approach may involve initializing an iterator with a starting key and then performing next operations to traverse a dataset within a specific database.

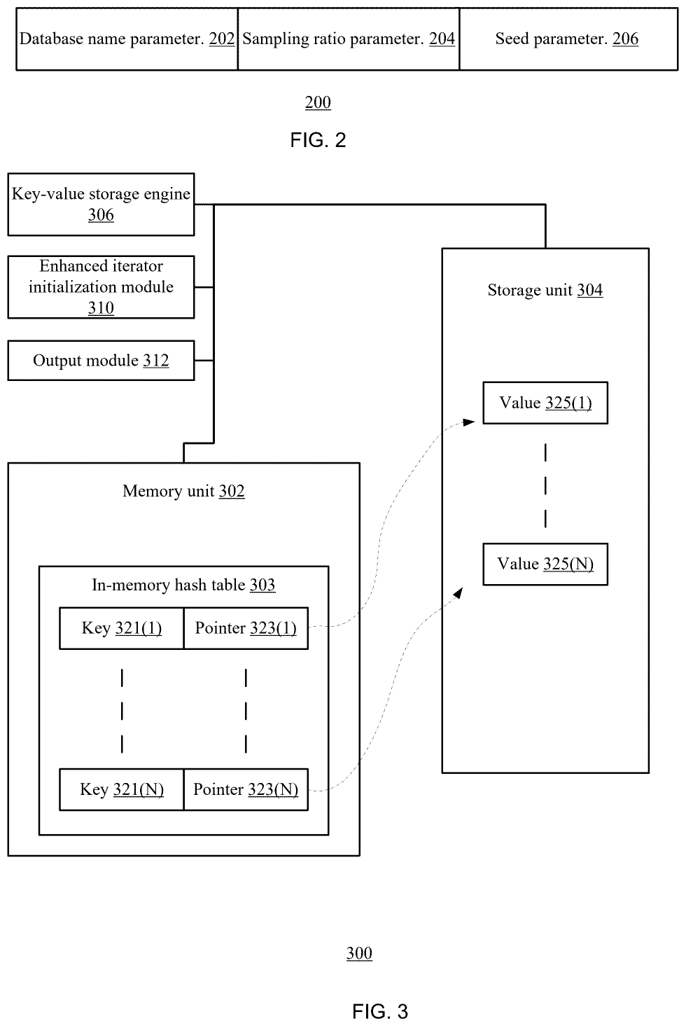

The enhanced iterator initialization function (denoted 200 in FIG. 2) accepts additional parameters beyond those used in conventional key-value iterator functions. The enhanced iterator initialization function may accept a database name parameter (denoted 202 in FIG. 2) that identifies the specific database or logical bucket within the key-value storage engine where the data resides. The start key parameter may specify the initial position from which iteration begins within the identified database.

The enhanced iterator initialization function may further accept a sampling ratio parameter (denoted 204 in FIG. 2) that determines a proportion of data to be scanned from the database. The sampling ratio parameter may control what fraction of the total dataset will be included in the sampling operation. In some cases, the sampling ratio parameter may be expressed as a decimal value between 0 and 1, where a value of 0.1 would indicate that 10% of the data should be sampled.

The enhanced iterator initialization function may also accept a seed parameter (denoted 206 in FIG. 2) that serves as a randomization seed for generating pseudo-random sequences. The seed parameter may enable reproducible random sampling operations, where the same seed value will produce the same sampling results across multiple executions. In some cases, the seed parameter may be implemented as a long integer value that provides sufficient range for generating diverse randomization patterns.

The enhanced iterator initialization function may enable sampling operations to be performed directly within the key-value storage engine without requiring separate preprocessing steps or intermediate data transfers. The function may utilize the sampling ratio parameter and seed parameter to determine which key-value pairs will be selected and in what order they will be returned during iteration. The enhanced iterator initialization function may facilitate the generation of randomized permutations over subsets of the dataset based on the specified parameters.

The random permutation process may employ an invertible hash function that can be generated differently for each seed parameter. The invertible hash function provides a mathematical mapping where each input value corresponds to a unique output value, and the mapping can be reversed to recover the original input. In some cases, the hash function domain and range both span from 0 to N-1, where N represents the number of slots in the hash table.

The invertible hash function may utilize various mathematical operations to achieve the desired permutation properties. In some cases, multiplication by an odd constant may be employed, where the hash function takes the form h(x)=x constant, provided that the constant value is odd. The odd constraint ensures that the multiplication operation remains invertible within the modular arithmetic domain.

Addition operations may also be incorporated into the hash function design. In some cases, the hash function may take the form h(x)=x+constant, where a constant value is added to the input. This additive operation maintains invertibility since the constant can be subtracted to recover the original value.

Bit rotation operations may provide another mechanism for creating invertible hash functions. In some cases, bit rotation may be implemented as h(x)=(x<<constant)| (x>> (N-constant)), where the input value undergoes both left and right bit shifts that are combined using a bitwise OR operation. The rotation operation preserves all bits while changing their positions, maintaining invertibility.

The seed parameter may influence the selection and configuration of these operations. In some cases, different seed values may result in different constant values being used in the mathematical operations. The seed may determine which specific invertible operation or combination of operations is applied, allowing for the generation of multiple distinct hash functions from the same underlying mathematical framework. In some cases, the seed value may be incorporated directly as the constant parameter in the various operations, enabling a wide range of hash function variations corresponding to different seed inputs.

The random permutation algorithm operates over n+l bits where l represents a maximum number of collisions within a slot. In some cases, the maximum number of collisions within a slot L=2^{l} where l<n, with l chosen large enough so the probability of having more than L collisions within a bucket may be negligibly small. The algorithm defines a random permutation over a world size of N×L, where N represents the number of slots in the hash table.

The sequential algorithm comprises specific initialization and iterative steps for generating randomized output. The algorithm initializes a counter i to 1 and computes H as hash (i, seed). The algorithm then iteratively processes slots within the hash table to output key-value pairs from non-empty slots while incrementing the counter until a desired number of outputs M may be reached.

During iteration, when a slot H contains data, the algorithm outputs the contents of slot T[H] and increments counter i. The algorithm then computes a new hash value H as hash (i, seed) for the next iteration. When a slot H may be empty, the algorithm computes H as hash (H, seed) to find a next slot without incrementing the counter i. This approach allows the algorithm to skip empty slots while maintaining the randomized sequence.

The sequential algorithm iterates over the hash table without requiring additional memory for storing additional data structures. In some cases, the algorithm avoids memory overhead by operating directly on the existing hash table structure and using the invertible hash function to generate slot addresses dynamically. The algorithm emits key-value pairs based on content of chosen slots through this iterative process, where each slot selection may be determined by the hash function computation using the current counter value or previous hash result as input along with the seed parameter.

The random permutation operates over a subset of the dataset based on the sampling ratio and seed parameters. In some cases, the sampling ratio determines how many elements M may be output from the total dataset, while the seed parameter influences the specific sequence of slot selections through the hash function computations. The algorithm continues until the specified number of outputs M may be generated, providing both sampling and shuffle functionality within the same operation.

In some cases, the method for performing sampling operations within a key-value storage engine may be executed on a dedicated processor external to a system CPU. The dedicated processor may be selected from the group consisting of an Application-Specific Integrated Circuit (ASIC) and a Field-Programmable Gate Array (FPGA). This configuration may provide computational advantages by offloading data processing operations from the main CPU to specialized hardware components.

When implemented on an ASIC, the dedicated processor may be specifically designed and optimized for the sampling and shuffle operations described herein. The ASIC implementation may provide fixed hardware circuits tailored to execute the invertible hash functions and random permutation algorithms with enhanced performance characteristics. In some cases, the ASIC may include dedicated memory interfaces and processing units configured to handle the key-value storage operations without requiring intervention from the system CPU.

Alternatively, when implemented on an FPGA, the dedicated processor may provide reconfigurable hardware that can be programmed to execute the sampling operations. The FPGA implementation may allow for flexibility in modifying the hash function operations and permutation algorithms based on different seed parameters and sampling ratios. In some cases, the FPGA may be configured with custom logic blocks that handle the iterator initialization function and the sequential algorithm for emitting key-value pairs.

The enhanced iterator initialization function may provide direct access from an AI processor, thereby circumventing a CPU subsystem during data processing operations. In some cases, the AI processor may be a Graphics Processing Unit (GPU) or other specialized AI processing hardware. This direct access configuration may eliminate the need for data to pass through the main CPU, reducing latency and improving overall system performance.

When the AI processor accesses the enhanced iterator initialization function directly, the sampling ratio parameter and seed parameter may be transmitted directly to the dedicated processor without CPU intervention. In some cases, this direct communication path may enable the AI processor to initiate multiple concurrent shuffle operations on identical data without modifying the underlying index or data structures stored in the key-value storage engine.

The dedicated processor may handle the execution of the random permutation over the subset of the dataset while the AI processor continues with other computational tasks. In some cases, this parallel processing approach may allow the AI training workflows to proceed with reduced computational bottlenecks. The dedicated processor may return the randomized permutation results directly to the AI processor, maintaining the direct data path and circumventing the CPU subsystem entirely during the data processing operations.

In some cases, data processing involves arrays of vectors that may be handled through specialized consolidation techniques. When dealing with small to medium-sized datasets that can be accommodated entirely in memory, the key-value storage system may adopt a consolidation approach that differs from conventional data handling methods.

The key-value storage system may consolidate entire arrays of vectors into a single value while retaining internal structure details. This consolidation process allows the system to maintain the organizational integrity of the vector data while presenting the consolidated information as a unified value within the key-value framework. The internal structure details may include vector dimensions, data types, ordering information, and relationships between individual vectors within the array.

In some cases, the system can load all data into memory in a single I/O operation when requested for array-based data processing. This single I/O operation approach may reduce the overhead associated with multiple memory access operations that would otherwise be performed when loading individual vector elements separately. The consolidated structure enables the system to retrieve the entire dataset through one memory access operation, thereby streamlining the data loading process.

Following the single I/O operation loading process, the random permutation algorithm described herein may be applied to the loaded data. The application of the random permutation algorithm to the consolidated vector arrays allows for efficient sampling and shuffling operations to be performed on the in-memory dataset. The permutation operations may be executed on the consolidated data structure while preserving the ability to access individual vector elements as needed for the AI training workflow.

The consolidation approach may be particularly suitable for scenarios where the dataset size allows complete memory accommodation, enabling the system to leverage the benefits of in-memory processing while maintaining the flexibility of the key-value storage paradigm. In some cases, the consolidated vector arrays may be processed using the same invertible hash functions and permutation techniques described for other embodiments of the key-value storage system.

The key-value storage engine operates in conjunction with the enhanced iterator initialization module, permutation engine, and output module to perform sampling and shuffle operations for AI training workflows. In some cases, the system begins operation when the enhanced iterator initialization module receives parameters including a database name, a start key, a sampling ratio parameter, and a seed parameter. The sampling ratio parameter may determine the proportion of data to be scanned from the database, while the seed parameter may serve as a randomization seed for generating reproducible results across multiple operations.

The permutation engine may execute a random permutation over a subset of the dataset based on the received sampling ratio and seed parameters. In some cases, the permutation engine employs an invertible hash function that can be generated differently for each seed value. The invertible hash function may utilize various operations such as multiplication by an odd constant, addition of a constant, or bit rotation operations. The seed parameter may be integrated as constants in these operations to generate a multitude of hash functions corresponding to distinct seeds.

When the key-value storage engine comprises an in-memory hash table, the hash table may comprise N=2ⁿ slots for some n, which accommodate M entries. The distribution of entries across slots may adhere to balls and bins principles. In some cases, the system defines a random permutation over n+1 bits, where 1 represents the maximum number of collisions within a slot. The value of 1 may be chosen to be large enough so that the probability of having more than L collisions within a bucket becomes negligibly small.

The output module may return values based on the randomized permutation using iterator operations. In some cases, the output module emits key-value pairs based on content of chosen slots using a sequential algorithm that iterates over the hash table. The sequential algorithm may begin with initialization of a counter i=1 and calculation of H=hash (i, seed). The algorithm may continue while i is less than or equal to M, where M represents the desired number of outputs. When the hash table position T[H] contains data, the system may output T[H] and increment the counter i. When T[H] is empty, the system may calculate a new hash value H=hash (H, seed) and continue the iteration process.

The system may eliminate intermediate data transfers by performing all sampling and shuffle operations directly within the key-value storage engine. In some cases, the system obviates the need to access data that is not selected during the sampling procedure from the storage media, as manipulations are conducted within the confines of the in-memory hash table. This approach may minimize data movement bottlenecks and reduce computational overheads associated with traditional data preprocessing pipelines.

For datasets containing arrays of vectors that can be accommodated entirely in memory, the system may consolidate the entire array into a single value while retaining internal structure details. In some cases, the system can load all data into memory in a single I/O operation when requested, after which the random permutation algorithm is applied to facilitate access to processed data.

The system may operate on a dedicated processor external to the system CPU, such as an ASIC or FPGA. In some cases, this configuration delegates computationally intensive shuffle and sampling operations to specialized hardware, thereby reducing bottlenecks within the system architecture. The API may be accessed directly from AI processors such as GPUs, circumventing the CPU subsystem and streamlining data flow and processing for AI training workflows.

The key-value storage engine provides a foundational data organization structure that facilitates efficient data management and retrieval operations. In some cases, data may be organized as key-value pairs within the key-value storage engine, where each key-value pair comprises a unique identifier key and a corresponding value. The unique identifier key may serve as a reference point for accessing the associated value, enabling rapid data retrieval and manipulation operations.

The key-value storage engine may be structured as an in-memory hash table, where the keys are maintained in memory while the associated values are stored on a storage device. In some cases, each entry in the hash table points to a location of an entry value on storage media, creating a separation between the indexing structure and the actual data storage. This configuration allows the hash table to function as a mapping mechanism that maintains references to actual data stored on persistent storage devices while keeping the indexing structure in memory for enhanced access performance.

The separation of keys and values provides computational advantages by maintaining frequently accessed indexing information in high-speed memory while storing the larger data payloads on storage devices. In some cases, the keys stored in memory enable rapid lookup operations and hash computations without requiring access to the storage device during the initial phases of data retrieval. The values stored on the storage device may be accessed only when specifically requested, reducing memory overhead and enabling the system to handle datasets larger than available memory capacity.

The hash table may comprise N=2ⁿ slots for some integer n, which accommodate M entries. In some cases, the selection of N=2ⁿ slots provides computational advantages for hash function operations and memory addressing schemes. The parameter n may be chosen based on the expected data volume and performance requirements of the storage engine.

Distribution of entries across the N=2ⁿ slots may adhere to balls and bins principles. In some cases, the balls and bins model describes how M entries (balls) are distributed among N slots (bins) in the hash table. This distribution pattern may influence collision rates and access patterns within the hash table structure. The balls and bins principles may govern the statistical properties of entry placement, where entries are distributed across available slots according to hash function outputs.

In some cases, the hash table configuration accommodates varying loads where M entries are distributed across the available N slots. The relationship between M and N may influence the collision characteristics and performance metrics of the storage engine. When M entries are placed into N=2ⁿ slots, the distribution may follow probabilistic patterns consistent with random placement models, affecting the efficiency of data access operations.

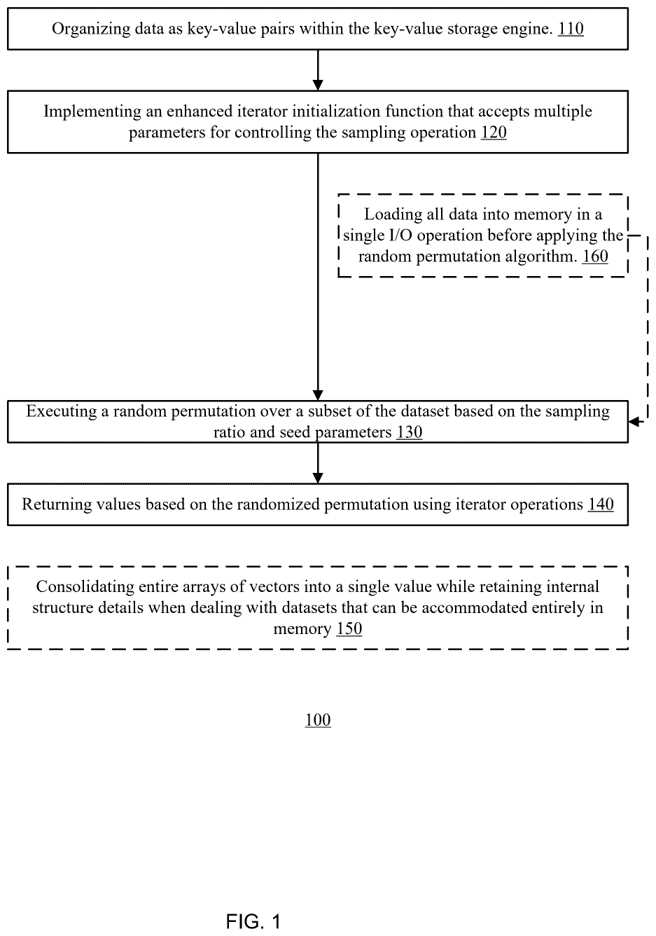

FIG. 1 illustrates an example of method 100 for performing sampling operations within a key-value storage engine for AI training workflows may begin at step 110 with organizing data as key-value pairs within the key-value storage engine. In some cases, each key may be stored in memory and points to a corresponding value stored in a storage unit. The key-value storage engine may be structured as an in-memory hash table, where each entry points to a location of an entry value on storage media. The hash table may comprise N=2ⁿ slots for some n, which accommodate M entries, where distribution of entries across slots adheres to balls and bins principles.

At step 120, method 100 may include implementing an enhanced iterator initialization function that accepts multiple parameters for controlling the sampling operation. The enhanced iterator initialization function may accept a database name parameter that identifies the specific database or logical bucket within the key-value storage engine where the data resides. The function may also accept a start key parameter that specifies the initial position from which iteration begins within the identified database. Additionally, the function may accept a sampling ratio parameter that determines a proportion of data to be scanned from the entire database, where the sampling ratio parameter may control what fraction of the total dataset will be included in the sampling operation. The function may further accept a seed parameter that serves as a randomization seed for generating pseudo-random sequences, enabling reproducible random sampling operations where the same seed value will produce the same sampling results across multiple executions.

At step 130, method 100 may include executing a random permutation over a subset of the dataset based on the sampling ratio and seed parameters. The random permutation process may employ an invertible hash function that can be generated differently for each seed parameter. The invertible hash function may utilize various mathematical operations including multiplication by an odd constant, addition of a constant, or bit rotation operations. The seed parameter may influence the selection and configuration of these operations, where different seed values may result in different constant values being used in the mathematical operations. The random permutation may operate over n+1 bits where 1 represents a maximum number of collisions within a slot, and the system may define a random permutation over a world size of N×L, where N represents the number of slots in the hash table.

At step 140, method 100 may include returning values based on the randomized permutation using iterator operations. The system may emit key-value pairs based on content of chosen slots using a sequential algorithm that iterates over the hash table without requiring additional memory for storing additional data structures. The sequential algorithm may begin with initialization of a counter i=1 and calculation of H=hash (i, seed). The algorithm may continue while i is less than or equal to M, where M represents the desired number of outputs. When the hash table position T[H] contains data, the system may output T[H] and increment the counter i. When T[H] may be empty, the system may calculate a new hash value H=hash (H, seed) and continue the iteration process. This approach may allow the algorithm to skip empty slots while maintaining the randomized sequence, thereby performing sampling operations directly within the key-value storage engine without requiring intermediate data transfers.

In some cases, method 100 may include additional steps for specialized processing scenarios. At step 150, method 100 may include consolidating entire arrays of vectors into a single value while retaining internal structure details when dealing with datasets that can be accommodated entirely in memory. The consolidation process may allow the system to maintain the organizational integrity of the vector data while presenting the consolidated information as a unified value within the key-value framework. The internal structure details may include vector dimensions, data types, ordering information, and relationships between individual vectors within the array.

At step 160, method 100 may include loading all data into memory in a single I/O operation before applying the random permutation algorithm. This single I/O operation approach may reduce the overhead associated with multiple memory access operations that would otherwise be performed when loading individual vector elements separately. The consolidated structure may enable the system to retrieve the entire dataset through one memory access operation, thereby streamlining the data loading process and facilitating efficient application of the random permutation algorithm to the loaded data.

Method 100 may be executed on a dedicated processor external to a system CPU, where the dedicated processor may be selected from the group consisting of an Application-Specific Integrated Circuit (ASIC) and a Field-Programmable Gate Array (FPGA). In some cases, method 100 may provide direct access from an AI processor such as a GPU, thereby circumventing a CPU subsystem and enabling the AI processor to initiate multiple concurrent shuffle operations on identical data without modifying the underlying index or data structures stored in the key-value storage engine.

According to an embodiment one or more processors are programmed to act as at least one of the key-value storage engine, the enhanced iterator initialization module, the permutation engine, and the like.

FIG. 3 illustrates an example of a system 300 that includes:
1. Memory unit 302.
2. Storage unit 304.
3. Key-value storage engine 306 configured to organize data as key-value pairs, where each key is stored in memory unit 302 and points to a corresponding value stored in storage unit 304. FIG. 3 illustrates an in-memory hash table 303 associated with the key-value storage engine as being stored in memory unit 302. The an in-memory hash table 303 is illustrated as including N keys 321(1)-321(N) and associated pointers 323(1)-323(N) that point to values 325(1)-325(N) stored in the storage unit.
4. Enhanced iterator initialization module 308 configured to accept a database name, a start key, a sampling ratio parameter that determines a proportion of data to be scanned from an entire database and a seed parameter that serves as a randomization seed.
5. Permutation engine 310 configured to execute a random permutation over a subset of the dataset based on the sampling ratio and seed parameters.
6. Output module 312 configured to return values based on the randomized permutation using iterator operations, wherein sampling operations are performed directly within the key-value storage engine without requiring intermediate data transfers. Output module 312 may be a communication unit.

A number of implementations have been described. Nevertheless, it will be understood that various modifications may be made without departing from the spirit and scope of the disclosure. Accordingly, other implementations are within the scope of the following claims.

Any reference to “may be” should also refer to “may not be”.

The application may be implemented in any key value system illustrated in any one of the following patent applications, all being incorporated herein by reference: U.S. patent application Ser. No. 19/181,198 filing date Apr. 16, 2025, U.S. patent application Ser. No. 18/976,209 filing date Dec. 10, 2024, U.S. patent application Ser. No. 18/600,706 filing date Mar. 9, 2024, U.S. patent application Ser. No. 18/449,693 filing date Aug. 14, 2023, U.S. Pat. No. 11,914,470 filing date Dec. 20, 2021, U.S. Pat. No. 12,277,340 filing date Oct. 27, 2020, U.S. Pat. No. 11,860,844 filing date Oct. 27, 2020.

In the foregoing detailed description, numerous specific details are set forth to provide a thorough understanding of the one or more embodiments of the disclosure. However, it will be understood by those skilled in the art that the present one or more embodiments of the disclosure may be practiced without these specific details. In other instances, well-known methods, procedures, and components have not been described in detail so as not to obscure the present one or more embodiments of the disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present one or more embodiments of the disclosure and in order not to obfuscate or distract from the teachings of the present one or more embodiments of the disclosure.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system and any other component should be applied mutatis mutandis to a method that may be executed by a system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any combination of any module or unit listed in any of the figures, any part of the specification and/or any claims may be provided. Especially any combination of any claimed feature may be provided.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks, circuit elements, or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Any reference to “consisting”, “having” and/or “including” should be applied mutatis mutandis to “consisting” and/or “consisting essentially of”.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather, the scope of the embodiments of the disclosure is defined by the appended claims and equivalents thereof.

1. A method for performing sampling operations within a key-value storage engine for AI training workflows, comprising:
organizing data as key-value pairs within the key-value storage engine, where each key is stored in memory and points to a corresponding value stored in a storage unit;
implementing an enhanced iterator initialization function that accepts a database name, a start key, a sampling ratio parameter that determines a proportion of data to be scanned from an entire database, and a seed parameter that serves as a randomization seed;
executing a random permutation over a subset of the dataset based on the sampling ratio and seed parameters; and
returning values based on the randomized permutation using iterator operations, thereby performing sampling operations directly within the key-value storage engine without requiring intermediate data transfers.

2. The method of claim 1, wherein the key-value storage engine comprises an in-memory hash table, where each entry points to a location of an entry value on storage media.

3. The method of claim 2, wherein the hash table comprises N slots, which accommodate M entries, where distribution of entries across slots adheres to balls and bins principles.

4. The method of claim 1, wherein executing the random permutation comprises employing an invertible hash function that can be generated differently for each seed.

5. The method of claim 4, wherein the invertible hash function utilizes operations selected from the group consisting of multiplication by an odd constant, addition of a constant, and bit rotation operations.

6. The method of claim 3, wherein executing the random permutation comprises defining a random permutation over n+1 bits where 1 represents a maximum number of collisions within a slot.

7. The method of claim 1, wherein returning values comprises emitting key-value pairs based on content of chosen slots using a sequential algorithm that iterates over the hash table without requiring additional memory for storing additional data structures.

8. The method of claim 1, wherein the method is executed on a dedicated processor external to a system CPU.

9. The method of claim 8, wherein the dedicated processor is selected from the group consisting of an ASIC and an FPGA.

10. The method of claim 1, further comprising consolidating an entire array of vectors into a single value while retaining internal structure details when dealing with datasets that can be accommodated entirely in memory, and loading all data into memory in a single I/O operation before applying the random permutation.

11. A system for performing sampling operations within a key-value storage engine for AI training workflows, comprising:
a key-value storage engine configured to organize data as key-value pairs, where each key is stored in memory and points to a corresponding value stored in a storage unit;
an enhanced iterator initialization module configured to accept a database name, a start key, a sampling ratio parameter that determines a proportion of data to be scanned from an entire database, and a seed parameter that serves as a randomization seed;
a permutation engine configured to execute a random permutation over a subset of the dataset based on the sampling ratio and seed parameters; and
an output module configured to return values based on the randomized permutation using iterator operations, wherein sampling operations are performed directly within the key-value storage engine without requiring intermediate data transfers.

12. The system of claim 11, wherein the key-value storage engine comprises an in-memory hash table, where each entry points to a location of an entry value on storage media.

13. The system of claim 12, wherein the hash table comprises N slots, which accommodate M entries, where distribution of entries across slots adheres to balls and bins principles.

14. The system of claim 11, wherein the permutation engine employs an invertible hash function that can be generated differently for each seed.

15. The system of claim 14, wherein the invertible hash function utilizes operations selected from the group consisting of multiplication by an odd constant, addition of a constant, and bit rotation operations.

16. The system of claim 11, further comprising a dedicated processor external to a system CPU, wherein the dedicated processor is configured to execute the permutation engine and is selected from the group consisting of an ASIC and an FPGA.

17. A non-transitory computer-readable storage medium storing instructions that, when executed by a processor, cause the processor to perform operations comprising:
organizing data as key-value pairs within a key-value storage engine, where each key is stored in memory and points to a corresponding value stored in a storage unit;
implementing an enhanced iterator initialization function that accepts a database name, a start key, a sampling ratio parameter that determines a proportion of data to be scanned from an entire database, and a seed parameter that serves as a randomization seed;
executing a random permutation over a subset of the dataset based on the sampling ratio and seed parameters using an invertible hash function; and
returning values based on the randomized permutation using iterator operations, thereby performing sampling operations directly within the key-value storage engine.

18. The non-transitory computer-readable storage medium of claim 17, wherein the key-value storage engine comprises an in-memory hash table, where each entry points to a location of an entry value on storage media, and wherein the hash table comprises N slots which accommodate M entries.

19. The non-transitory computer-readable storage medium of claim 18, wherein the invertible hash function utilizes operations selected from the group consisting of multiplication by an odd constant, addition of a constant, and bit rotation operations.

20. The non-transitory computer-readable storage medium of claim 19, wherein returning values comprises emitting key-value pairs based on content of chosen slots using a sequential algorithm that iterates over the hash table without requiring additional memory for storing additional data structures.
